(19) United States
(12) Patent Application Publication
(10) Pub. No.: US 2007/0259249 A1
(43) Pub. Date: Nov. 8, 2007

(54) SEPARATOR FOR FUEL CELL

(75) Inventors: Joon Hyung Lee, Yongin-si (KR); Young Seung Na, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: SAMSUNG SDI CO., LTD., Suwon-si (KR)

(21) Appl. No.: 11/740,818

(22) Filed: Apr. 26, 2007

(30) Foreign Application Priority Data
May 3, 2006 (KR) 10-2006-0040221

(51) Int. Cl. H01M 8/02; B32B 3/30

(52) U.S. Cl. 429/38; 428/167

(57) ABSTRACT

Disclosed is a separator for a fuel cell. The separator includes a plate configured to face an anode electrode and a cathode electrode of a fuel cell to generate electricity by electrochemical reaction between hydrogen and oxygen. The separator includes channels through which fluid can flow and ribs forming the channels. At least one of the ribs includes a sloping end at an outlet end thereof. The sloping end has a first inclination angle relative to a surface of the plate. Water produced in the cathode electrode is easily discharged and air is smoothly supplied to the cathode electrode, thereby enhancing the power generation efficiency of the fuel cell.

### CROSS-REFERENCE TO RELATED APPLICATIONS

This application claims the benefit of Korean Patent Application No. 10-2006-0040221, filed on May 3, 2006, in the Korean Intellectual Property Office, the disclosure of which is incorporated herein by reference in its entirety.

### BACKGROUND

1. Field

The present invention relates to a fuel cell, and more particularly, to a separator for a fuel cell.

2. Description of the Related Technology

A fuel cell is classified into a polymer electrolyte membrane fuel cell (PEMFC) and a direct methanol fuel cell (DMFC); a phosphoric acid fuel cell (PAFC); a molten carbon fuel cell (MCFC); a solid oxide fuel cell (SOFC); and so on. These fuel cells operate generally in the same principle, but they are different in the type of fuel, catalysts, electrolytes, and so on.

In general, the fuel cell is a power generating system that directly transforms chemical energy into electric energy using an electrochemical reaction between H₂ (hereinafter “hydrogen”) and O₂ (hereinafter “oxygen.”) In supplying hydrogen to a fuel cell system, hydrogen can be directly used in the reaction, or hydrocarbons such as methanol, ethanol, natural gas can be reformed to provide hydrogen. Further, in supplying oxygen to the fuel cell system, oxygen can be directly used, or air containing oxygen can be supplied. In supplying oxygen, an air pump or the like may be used. Meanwhile, the direct methanol fuel cell (DMFC) systems use a mixture of methanol and water as the fuel.

### SUMMARY OF CERTAIN INVENTIVE ASPECTS

One aspect of the invention provides a separator for use in a fuel cell. The separator comprises: a plate having a first edge and a second edge opposite from the first edge; an inlet formed adjacent to the first edge; an outlet formed adjacent to the second edge; and a plurality of ribs formed on a surface of the plate, the ribs being positioned between the inlet and the outlet and extending in a direction from the first edge to the second edge, thereby defining channels therebetween, each of the ribs comprising a first end portion adjacent to the inlet and a second end portion adjacent to the outlet, wherein at least one of the second end portions of the ribs comprises at least one surface generally not parallel to a surface perpendicular to the direction.

The at least one surface may comprise a surface forming an angle with the surface perpendicular to the direction, and the angle may be between about 35° and about 55°. The at least one of the second end portions may comprise step. The at least one of the second end portions may comprise a rounded surface.

The at least one of the second end portions may comprise a lateral surface substantially perpendicular to the surface of the plate and to the surface perpendicular to the direction, and the at least one of the second end portions may be tapered such that the lateral surface narrows toward the second edge. The lateral surface may narrow so as to sufficiently inhibit a liquid droplet from staying on the lateral surface while the liquid droplet travels in a direction from the first end portion to the second end portion due to gravity. The lateral surface may have a shape of a triangle with an apex pointing toward the second edge. The triangle may comprise a perpendicular triangle.

The plate may comprise a recess formed on the surface of the plate, and the plurality of ribs may be formed within the recess. The recess may comprise a first recessed portion permitting fluid communication between the inlet and the channels and a second recessed portion permitting fluid communication between the channels and the outlet, and the second recessed portion may narrow toward the outlet such that a fluid from at least one of the channels flows toward the outlet when the inlet is positioned higher than the outlet.

The second recessed portion may comprise at least one surface substantially not parallel to the surface of the plate, and the at least one surface may be generally not parallel to the surface perpendicular to the direction.

The at least one surface may be substantially planar. The at least one surface may form an angle with the surface perpendicular to the direction, and the angle may be between about 30° and about 45°.

The first recessed portion may widen as it extends from the inlet toward the channels. The at least part of the second recessed portion may be coated with a hydrophilic material. At least one of the channels may be coated with a hydrophilic material.

The separator may further comprise another plurality of ribs formed on another surface of the plate, the other plurality of ribs being positioned between the inlet and the outlet and extending in a direction from the first edge to the second edge, thereby defining channels therebetween, each of the other plurality of ribs comprising a first end portion adjacent to the inlet and a second end portion adjacent to the outlet, wherein at least one of the second end portions of the other plurality of ribs comprises at least one surface generally not parallel to a surface perpendicular to the direction.

Another aspect of the invention provides a fuel cell comprising: an electrode plate; and the separator described above, the separator being attached to the electrode plate with the surface of the plate facing the electrode.

Yet another aspect of the invention provides a method of operating the fuel cell described above. The method comprises: orienting the fuel cell such that the inlet is positioned higher than the outlet; supplying a reactant through the inlet; activating the electrode to form a liquid product; and draining the liquid product through the outlet.

Another aspect of the invention provides a fuel cell comprising: a first electrode plate; a second electrode plate; and the separator described above, the separator being interposed between the first and second electrode plates and attached to the first and second electrode plates.

Yet another aspect of the invention provides an apparatus comprising the separator described above, wherein the apparatus is selected from the group consisting of a self-contained fuel cell system, an electronic or electrical device comprising a fuel cell, and a transportation vehicle comprising a fuel cell.

A further aspect of the invention provides a cathode separator for a fuel cell, which has a structure to smoothly discharge water from a cathode electrode.

Another aspect of the invention provides a cathode separator for a fuel cell, in which a water outlet of ribs forming a channel is formed to have a slope, so that water produced in a cathode electrode and flowing along channels is smoothly discharged in the water outlet.

Still another aspect of the invention provides a cathode separator for a fuel cell, in which a predetermined slope is given to a bottom edge of an outlet header with respect to a horizon, so that water produced in a cathode electrode and discharged from a water outlet of a rib smoothly flows toward an outlet.

In some embodiments, the foregoing separator comprises a plate provided in a fuel cell that generates electricity by electrochemical reaction between a reactant such as hydrogen of hydrogen containing fuel as and an oxidant such as oxygen, and formed with channels through which fluid can flow, the separator comprising: a rib constituting the channel, wherein the rib comprises a sloping end placed at an outlet end thereof and having a first inclination angle to a surface of the plate.

In one embodiment, the first inclination angle of the sloping end ranges from about 40° to about 50°. In one embodiment, the plate comprises an inlet into which the reactant is introduced, and an inlet header connecting the inlet with the channel to communicate with each other. Further, the plate comprises an outlet through which products produced by reaction of the reactant are discharged, and an outlet header connecting the outlet with the channel to communicate with each other. In another embodiment, the sloping end faces the outlet header.

In some embodiments, the outlet header comprises a bottom edge having a second inclination angle to the channel with respect to the outlet. Further, the second inclination angle ranges from about 30° to about 45°. In some embodiments, the channel is coated with a hydrophilic material, and the outlet header is coated with a hydrophilic material. In some embodiments, the plate faces a cathode electrode into which the oxidant is introduced, and the products include water. In some embodiments, the outlet header is formed by partially cutting out the surface of the plate at predetermined depth from circumference of the outlet to the channel, and the height of the rib is equal to the depth of the outlet header. In some embodiments, the inlet header is formed by partially cutting out the surface of the plate at predetermined depth from circumference of the inlet to the channel.

### BRIEF DESCRIPTION OF THE DRAWINGS

These and other aspects and advantages of the invention will become apparent and more readily appreciated from the following description of certain embodiments, taken in conjunction with the accompanying drawings of which:

FIG. 1 is a plan view of a cathode separator according to an embodiment;

FIG. 2a is a perspective view of the cathode separator according to an embodiment;

FIGS. 2b to 2e are perspective views of second end portions of ribs according to another embodiment;

FIG. 3 is a plan view of a cathode separator according to another embodiment;

FIG. 4 is a schematic cross-sectional view of a unit cell; and

FIG. 5 is a plan view of a cathode separator used in the fuel cell of FIG. 4.

### DETAILED DESCRIPTION OF CERTAIN INVENTIVE EMBODIMENTS

Hereinafter, various embodiments of the present invention will be described with reference to accompanying drawings, wherein like numerals refer to like elements and repetitive descriptions will be avoided as necessary. In the illustrated embodiments, the shape and size of the elements and features shown in the drawings may be exaggerated.

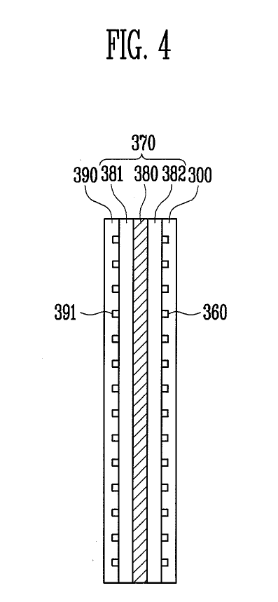

FIG. 4 is a schematic cross-sectional view of a unit fuel cell configuration. Referring to FIG. 4, the unit cell includes a membrane electrode assembly 370, a cathode separator 300 and an anode separator 390. In general, the membrane electrode assembly 370 includes an anode electrode 381, a cathode electrode 382 and an electrolyte membrane 380 interposed between the anode and cathode electrodes 381 and 382.

The cathode separator 300 is placed to contact the cathode electrode 382 and formed with air flow channels 360, through which oxygen is to be supplied to the cathode electrode 382. The electrochemical reaction of the fuel cell generates water at the cathode electrode 382. The water produced in the reaction flows along the channels 360 of the cathode separator 300 and is discharged to the outside.

The anode separator 390 is placed to contact the anode electrode 381 and formed with channels 391, through which fuel is supplied to the anode electrode 381. The reaction of the fuel cell at the anode electrode 381 generates carbon dioxide or the like, which flows along the channels 391 of the anode separator 390 and is discharged to the outside.

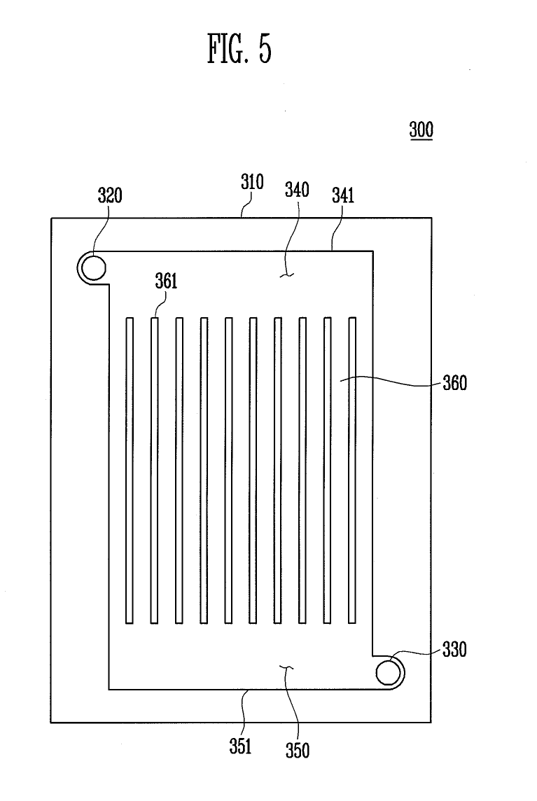

FIG. 5 is a plan view of one configuration of the cathode separator 300. Referring to FIG. 5, the cathode separator 300 includes an inlet 320, an outlet 330 and a plurality of ribs 361 provided in a recess formed in the cathode separator 300. In the illustrated configuration, the recess is defined by four edges including the top edge 341 and the bottom edge 351. The top edge 341 is generally parallel to the top edge 310 of the cathode separator 300. Air is introduced to the recessed space through the inlet 320 and flows downward along the channels 360 formed by ribs 361 via a space referred to as inlet header 340. Then, air passing through the channels 360 is discharged through the outlet 330 via another space referred to as outlet header 350, which is generally parallel with the top edge 310 of the cathode electrode 300.

Further, as described above, water produced in the cathode electrode 382 (refer to FIG. 4) falls to the outlet header 350 along the channels 360 due to its gravity and is discharged to the outside through the outlet 330. However, because the bottom edge 351 is in parallel with the top edge 310, some water falling to the outlet header 350 may not be easily drained through the outlet 330. Therefore, some water may be remained in the outlet header 350 and may obstruct air flow through the channels 360. Such obstruction may interfere supply of air to the cathode electrode 382 (refer to FIG. 4) and may further affect the power generation efficiency of the fuel cell system.

In addition, water produced in the cathode electrode 300 sometimes does not flow through the channels 360 and may stay at lower end portions of the channels 360 because of surface tension between the water drops and the surfaces of the channels 360. The water staying in the channels 360 interferes with smooth supply of air to various areas of the cathode electrode 300, thereby deteriorating the power generation efficiency of the fuel cell system.

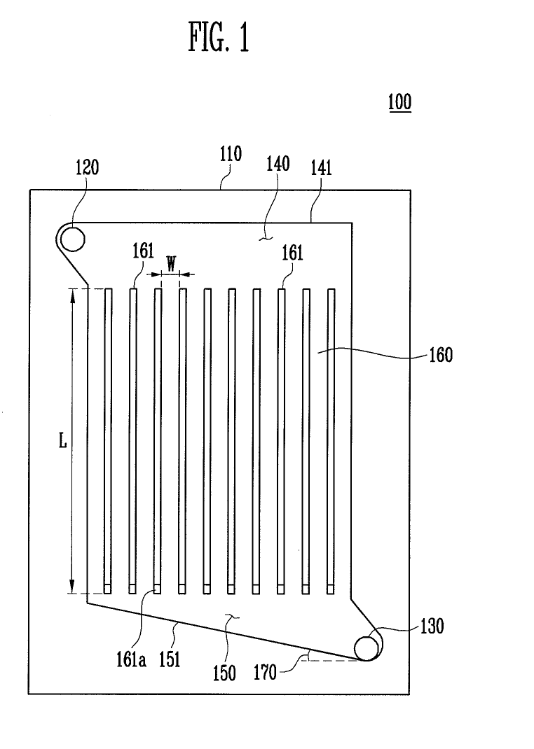

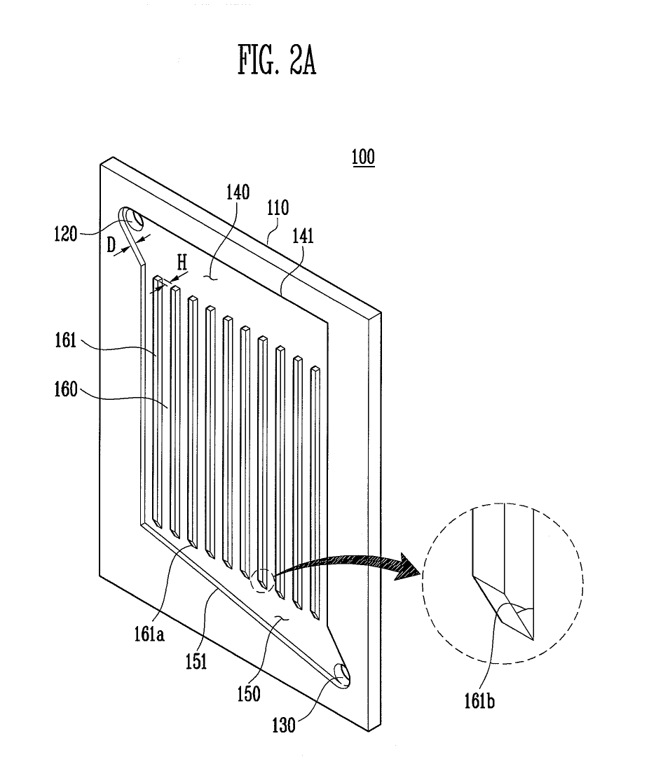

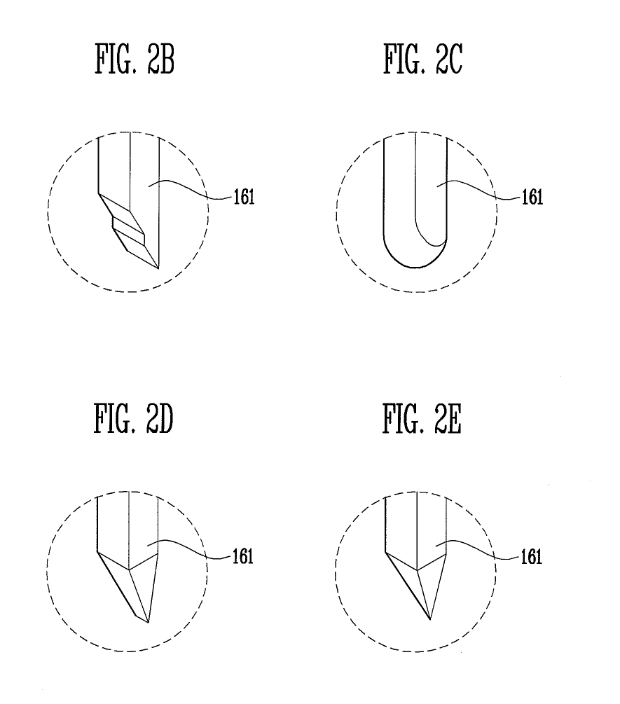

FIG. 1 is a plan view of a cathode separator according to an embodiment. FIG. 2a is a perspective view of the cathode separator of FIG. 1. Referring to FIGS. 1 and 2a, a cathode separator 100 according to an embodiment has a plate 110 that includes a recess on a surface thereof. The plate 100 includes an inlet 120, an inlet header 140, a plurality of channels 160, a plurality of ribs 161, an outlet header 150 and an outlet 130 in the recess.

The inlet 120 is positioned at an upper left corner of the recess, as shown in FIG. 1. The inlet 120 is configured to penetrate the plate 110. It will be appreciated that the configuration and position of the inlet 120 can be varied depending on the design of the separator.

The inlet header 140 refers to a space on an upper portion of the recess of the plate 110. The inlet header 140 has a bottom surface recessed into the plate 110. The bottom surface may be formed by partially cutting out the surface of the plate 110 around the inlet 120 to a predetermined depth. The predetermined depth may be between about 1 mm and about 2 mm. A top edge 141 of the inlet header 140 is substantially parallel to a top edge of the plate 110.

The plurality of ribs 161 are positioned below the inlet header 140 in substantially central region of the recess. The ribs 161 extend substantially parallel to one another and substantially perpendicular to the top edge 141 of the inlet header 140. The ribs 161 protrude from the bottom surface of the recess of the plate 110. In one embodiment, the ribs 161 are formed in parallel to one another at a predetermined interval. The predetermined interval W may be between about 0.8 mm and about 2 mm. A space between the adjacent ribs 161 forms a channel through which air and water can flow. The ribs 161 may have a height H (FIG. 2a) approximately equal to a depth D (FIG. 2a) of the inlet header 140 or the recess. In one embodiment, the ribs 161 have a height between about 1 mm and about 2 mm and a length L (FIG. 1) between about 32 mm and about 36 mm.

Each of the illustrated ribs 161 has an upper end immediately below the inlet header 140 and a lower end opposite from the upper end. In one embodiment, at least one of the ribs 161 includes a sloping end 161a at the lower end, as shown in FIG. 2a. The sloping end 161a has an inclined surface having a predetermined gradient toward the recessed surface of the plate 110. The sloping end 161a of the rib 161 serves to minimize a surface tension of water. In addition, the sloping end 161a has a predetermined angle 161b (FIG. 2a) of inclination with respect to the bottom surface of the plate, for example, about 35° to about 55°, optionally about 40° to about 50°. The predetermined angle may be one selected from 35°, 36°, 37°, 38°, 39°, 40°, 41°, 42°, 43°, 44°, 45°, 46°, 47°, 48°, 49°, 50°, 51°, 51°, 52°, 53°, 54°, and 55°.

The outlet 130 is positioned at a lower right corner of the recess. The outlet 130 is configured to penetrate the plate 110. It will be appreciated that the configuration and position of the outlet 130 can be varied depending on the design of the separator.

Like the inlet header 140, the outlet header 150 is recessed into the plate 100. In one embodiment, the outlet header 140 may be formed by partially cutting out the surface of the plate 110 around the outlet 130 to a predetermined depth. The predetermined depth may be between about 1 mm and about 2 mm.

The outlet header 140 is configured to be in fluid communication with the channels 160. In the illustrated embodiment, the outlet header 150 serves to collect water discharged from the channels 160 into the outlet 130. To enhance the collection of the outlet header 150, a bottom edge 151 of the outlet header 150 is formed at a predetermined angle 170 to a bottom edge of the plate 110 toward the outlet 130. Further, the outlet header 150 has an upper width facing the channel 160 and a lower width facing the outlet 130, in which the upper width is wider than the lower width. In the illustrated embodiment, the angle 170 may be optionally determined for allowing water discharged from the channel 160 to easily flow toward the outlet 130 along the bottom edge 151 of the outlet header 150. In one embodiment, the angle 170 may be between about 30° and about 45°. The angle 170 may be selected from 30°, 31°, 32°, 33°, 34°, 35°, 36°, 37°, 38°, 39°, 40°, 41°, 42°, 43°, 44°, and 45°.

In certain embodiments, a surface of the outlet header 150 may be coated with a hydrophilic material such as titanium dioxide, a silane coupling agent, a sealant, or the like. Such a hydrophilic material can also be applied to the channels 160.

The cathode separator 100 according to an embodiment operates as follows. Air introduced through the inlet 120 is distributed to the channels 160 via the inlet header 140. Then, air is supplied from each channel 160 to the cathode electrode 382 (FIG. 4) contacting the cathode separator 100. On the surface of the cathode electrode 382, oxygen in the air is reduced and water is produced. Then, water flows to the outlet header 150 along the channel 160 because of gravity. Because the ribs 161 have the sloping ends 161a having inclined surfaces at the lower parts thereof, water can smoothly flow to the outlet header 150 without being retained at the lower parts of the ribs 161.

Further, because the bottom edge 151 of the outlet header 150 is formed at a predetermined angle 170 with respect to the bottom edge of the plate 110, water collected in the outlet header 150 can smoothly flow down along the bottom edge 151 of the outlet header 150 and can be discharged to the outside through the outlet 130. In certain embodiments where the surface of the outlet header 150 is coated with a hydrophilic material, water can more smoothly flow and be discharged.

FIGS. 2b to 2e are perspective views of second end portions of ribs according to another embodiment. Referring to FIG. 2b, at least one of the second end portions of the ribs 121 according to another embodiment may have a step portion. Referring to FIG. 2c, at least one of the second end portions of the ribs 121 according to another embodiment may have a rounded surface. Referring to FIG. 2d, at least one of the second end portions of the ribs 121 according to another embodiment may be tapered such that the lateral surface narrows toward the second edge. Furthermore, referring to FIG. 2e, at least one of the second end portions of the ribs 121 according to another embodiment may have triangle shape lateral surface. Here, the triangle shape may comprise a perpendicular triangle.

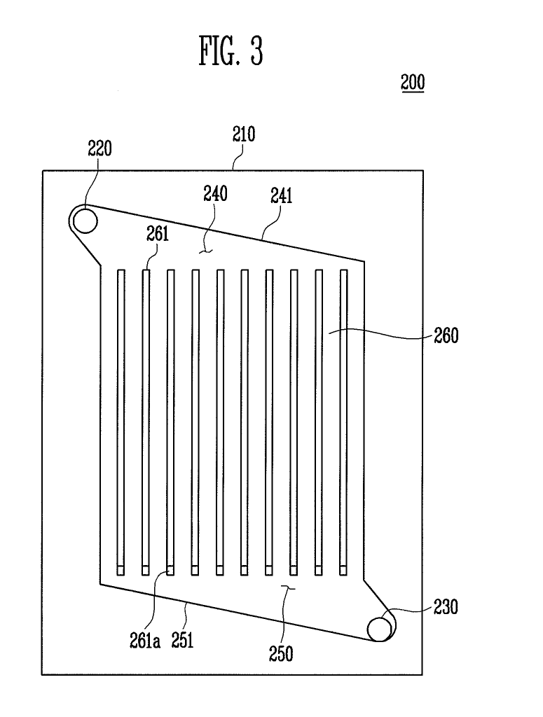

FIG. 3 is a plan view of a cathode separator according to another embodiment. Referring to FIG. 3, a cathode separator 200 according to this embodiment has a plate 210 that includes an inlet 220, an inlet header 240, a channel 260, a rib 261, an outlet header 250 and an outlet 230. Here, the cathode separator 200 of FIG. 3 has a configuration similar to that of the cathode separator 100 of FIG. 1, except for the shape of the inlet header 240.

The inlet header 240 is recessed into the plate 210. The inlet header 240 may be formed by partially cutting out the surface of the plate 210 around the inlet 220 to a predetermined depth. The predetermined depth may be between about 1 mm and about 2 mm.

A top edge 241 of the inlet header 240 is formed at a predetermined angle to a top edge of the plate 210 toward the inlet 220. The angle may be optionally determined for allowing air introduced through the inlet 220 to be uniformly distributed to the channels 260 through the inlet header 240. In one embodiment, the angle may be between about 30° and about 45°.

The configuration of the inlet header 240 minimizes air resistance even though air flows away from the inlet 220, thereby supplying air uniformly to the channels 260. The configurations of the other components of the cathode separator 200 may be as described above with respect to those of the cathode separator 100 of FIG. 1, and the description of the configurations is omitted.

In the foregoing embodiments, the cathode separator includes the inlet header, the channel and the outlet header on one side of the plate, but not limited thereto. Alternatively, the inlet header, the channel and the outlet header may be formed on the other side of the plate. Such a separator having the inlet headers, the channels and the outlet headers on both sides of the plate is useful in stacking a plurality of unit cells.

In another embodiment, the above-mentioned structures of the outlet header, the rib and the inlet header can apply to an anode separator. In this case, unreacted hydrogen containing fuel, which has not participated in a chemical reaction of an anode electrode, of liquid hydrogen containing fuel supplied to the anode electrode through the channels formed on the anode separator can be smoothly discharged from the channel.

According to an embodiment, water produced in the cathode electrode is easily discharged. Thus, it is possible to supply air smoothly to the cathode electrode, thereby enhancing the power generation efficiency of the fuel cell.

Although a few embodiments have been shown and described, it would be appreciated by those skilled in the art that changes might be made in this embodiment without departing from the principles and spirit of the invention, the scope of which is defined in the claims and their equivalents.

What is claimed is:

1. A separator for use in a fuel cell, comprising:
a plate having a first edge and a second edge opposite from the first edge;
an inlet formed adjacent to the first edge;
an outlet formed adjacent to the second edge; and
a plurality of ribs formed on a surface of the plate, the ribs being positioned between the inlet and the outlet and extending in a direction from the first edge to the second edge, thereby defining channels therebetween, each of the ribs comprising a first end portion adjacent to the inlet and a second end portion adjacent to the outlet, wherein at least one of the second end portions of the ribs comprises at least one surface generally not parallel to a surface perpendicular to the direction.

2. The separator of claim 1, wherein the at least one surface comprises a surface forming an angle with the surface perpendicular to the direction, and wherein the angle is between about 35° and about 55°.

3. The separator of claim 1, wherein the at least one of the second end portions comprises steps.

4. The separator of claim 1, wherein the at least one of the second end portions comprises a rounded surface.

5. The separator of claim 1, wherein the at least one of the second end portions comprises a lateral surface substantially perpendicular to the surface of the plate and to the surface perpendicular to the direction, and wherein the at least one of the second end portions is tapered such that the lateral surface narrows toward the second edge.

6. The separator of claim 5, wherein the lateral surface narrows so as to sufficiently inhibit a liquid droplet from staying on the lateral surface while the liquid droplet travels in a direction from the first end portion to the second end portion due to gravity.

7. The separator of claim 5, wherein the lateral surface has a shape of a triangle with an apex pointing toward the second edge.

8. The separator of claim 7, wherein the triangle comprises a perpendicular triangle.

9. The separator of claim 1, wherein the plate comprises a recess formed on the surface of the plate, and wherein the plurality of ribs are formed within the recess.

10. The separator of claim 9, wherein the recess comprises a first recessed portion permitting fluid communication between the inlet and the channels and a second recessed portion permitting fluid communication between the channels and the outlet, and wherein the second recessed portion narrows toward the outlet such that a fluid from at least one of the channels flows toward the outlet when the inlet is positioned higher than the outlet.

11. The separator of claim 10, wherein the second recessed portion comprises at least one surface substantially not parallel to the surface of the plate, and wherein the at least one surface is generally not parallel to the surface perpendicular to the direction.

12. The separator of claim 11, wherein the at least one surface is substantially planar, wherein the at least one surface forms an angle with the surface perpendicular to the direction, and wherein the angle is between about 30° and about 45°.

13. The separator of claim 10, wherein the first recessed portion widens as it extends from the inlet toward the channels.

14. The separator of claim 10, wherein at least part of the second recessed portion is coated with a hydrophilic material.

15. The separator of claim 1, wherein at least one of the channels is coated with a hydrophilic material.

16. The separator of claim 1, further comprising another plurality of ribs formed on another surface of the plate, the other plurality of ribs being positioned between the inlet and the outlet and extending in a direction from the first edge to the second edge, thereby defining channels therebetween, each of the other plurality of ribs comprising a first end portion adjacent to the inlet and a second end portion adjacent to the outlet, wherein at least one of the second end portions of the other plurality of ribs comprises at least one surface generally not parallel to a surface perpendicular to the direction.

17. A fuel cell comprising:
an electrode plate; and
the separator of claim 1, the separator being attached to the electrode plate with the surface of the plate facing the electrode.

18. A method of operating the fuel cell of claim 17,
orienting the fuel cell such that the inlet is positioned higher than the outlet;
supplying a reactant through the inlet;
activating the electrode to form a liquid product; and
draining the liquid product through the outlet.

19. A fuel cell comprising:
a first electrode plate;
a second electrode plate; and
the separator of claim 16, the separator being interposed between the first and second electrode plates and attached to the first and second electrode plates.

20. An apparatus comprising the separator of claim 1, wherein the apparatus is selected from the group consisting of a self-contained fuel cell system, an electronic or electrical device comprising a fuel cell, and a transportation vehicle comprising a fuel cell.
